(19) United States
(12) Patent Application Publication
(10) Pub. No.: US 2021/0011743 A1
(43) Pub. Date: Jan. 14, 2021

(54) METHOD AND SYSTEM OF INSTANTIATING PERSONA BASED USER INTERFACE NOTIFICATIONS

(71) Applicant: Ventech Solutions, Inc., Columbus, OH (US)

(72) Inventors: Matthew Canada, Rosedale, MD (US); Jerry Allen Craig, II, Knoxville, TN (US); Kathrine Dass, Severna Park, MD (US); Raja Krishnamurthy, Lewis Center, OH (US); David Anthony Rigsby, Heath, OH (US); Richard Nathan Toney, Windsor Mill, MD (US)

(21) Appl. No.: 16/510,701

(22) Filed: Jul. 12, 2019

(51) Int. Cl. G06F 9/451; H04L 12/24

(52) U.S. Cl. CPC G06F 9/451; H04L 67/42; H04L 41/22

(57) ABSTRACT

A method and system of instantiating a user interface (UI) notification. The method comprises accessing a persona configuration, the persona configuration specified at least in part based on one or more script agents, the script agents including script code arranged in accordance with an execution state flow associated with execution of a software program; executing, in one or more processors of a server device, object code of the software program in accordance with the execution state flow in conjunction with the one or more script agents to generate a set of resultant parameters; and transmitting, to a UI display of a display device that is authorized in association with the persona configuration, information instantiated based on at least a subset of the resultant parameters.

### TECHNICAL FIELD

The disclosure herein relates to instantiation of notifications in a focused, secure manner in conjunction with execution of software programs.

### BACKGROUND

For enterprise organizations deploying critical software system infrastructure and components, it is important to ensure that their enterprise software applications and systems enable access to information in a secure and targeted manner, sometimes even on a need-to-know basis. Yet further, an enterprise software program or application once executed may generate myriad types of voluminous information, potentially making it difficult to get the most relevant information, and only the most relevant information, delivered or presented appropriately to a given functional user type. However, often the necessary system or applications structure and solutions may be missing or inadequate to generate such information solutions relating to a software system as deployed. A solution which contributes to dissemination and presentation of most relevant enterprise information to a given user or user type in a targeted, secure manner of distribution becomes desirable and provides a competitive advantage.

### BRIEF DESCRIPTION OF THE DRAWINGS

FIG. 1 illustrates, in an example embodiment, a networked system of instantiating persona based user interface (UI) notifications in software program execution.

FIG. 2 illustrates, in one example embodiment, an architecture of a networked server system for instantiating persona based user interface (UI) notifications in software program execution.

FIG. 3 illustrates a persona based UI notification as instantiated in an illustrative example.

FIG. 4 illustrates a persona based UI notification as instantiated in a further illustrative example.

FIG. 5 illustrates a method of operation, in one example embodiment, in a networked system of instantiating persona based user interface (UI) notifications in software program execution.

### DETAILED DESCRIPTION

Among other benefits and technical effects, it is recognized that, while an enterprise software program or application upon execution may generate myriad types of voluminous information, potentially making it difficult to get the most relevant information, solutions of the disclosure herein enable filtering and presentation of the most relevant information, delivered or presented appropriately to a given persona or functional user type. The disclosure herein provides solutions that advance dissemination and presentation of most relevant enterprise information to a given user or user type in a targeted, secure manner.

In accordance with a first example embodiment, a method of instantiating or manifesting a user interface (UI) notification is provided. The method comprises accessing a persona configuration, the persona configuration specified at least in part based on one or more script agents, the script agents including script code arranged in accordance with an execution state flow associated with execution of a software program; executing, in one or more processors of a server device, object code of the software program in accordance with the execution state flow in conjunction with the one or more script agents to generate a set of resultant parameters; and transmitting, to a UI display of a display device that is authorized in association with the persona configuration, information instantiated based on at least a subset of the resultant parameters.

In accordance with a second example embodiment, a non-transitory computer readable medium having program instructions for instantiating a notification UI is disclosed. The non-transitory computer readable medium includes program instructions executable in a processor of a server computing device to access a persona configuration, the persona configuration specified at least in part based on one or more script agents arranged in an execution state flow associated with execution of a software program; execute, in one or more processors, object code of the software program in accordance with the execution state flow in conjunction with the one or more script agents to generate a set of resultant parameters; and transmit, to a user interface (UI) display of a display device that is authorized in association with the persona configuration, information instantiated based at least in part on the resultant parameters.

In accordance with a third example embodiment, a system for instantiating a UI notification is provided. The system includes a server computing device that includes a non-transitory memory for storing a software program, and one or more processors for executing the software program in an execution state flow or progression of program execution states. The software program includes instructions executable in the processor to access a persona configuration, the persona configuration specified at least in part based on one or more script agents arranged in an execution state flow associated with execution of a software program; execute, in the one or more processors, object code of the software program in accordance with the execution state flow in conjunction with the one or more script agents to generate a set of resultant parameters; and transmit, to a user interface (UI) display of a display device that is authorized in association with the persona configuration, information instantiated based at least in part on the resultant parameters.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of logic instructions that are executable by one or more processors of a computing device, including a server computing device. These instructions may be carried on a computer-readable medium. In particular, machines shown with embodiments herein include processor(s) and various forms of memory for storing data and instructions. Examples of computer-readable mediums and computer storage mediums include portable memory storage units, and flash memory (such as carried on smartphones). A server computing device as described herein utilizes processors, memory, and logic instructions stored on computer-readable medium. Embodiments described herein may be implemented in the form of computer processor-executable logic instructions or programs stored on computer memory mediums.

### System Description

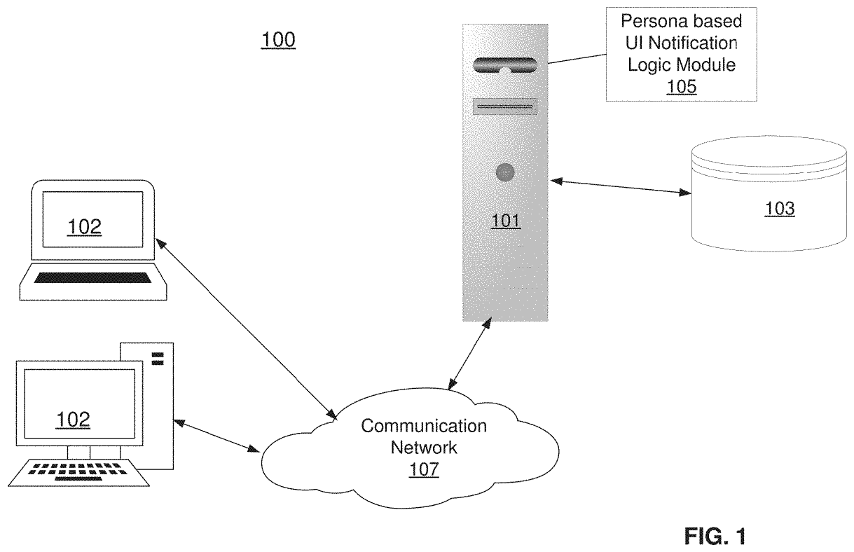

FIG. 1 illustrates, in an example embodiment, a networked system 100m of instantiating persona based user interface (UI) notifications in software program execution. In the example embodiment 100 persona based UI notification logic module 105 is hosted at server computing device 101. While remote server computing device 101 (also referred to herein as server 101 and server device 101) is depicted as including persona based UI notification logic module 105, it is contemplated that, in alternate embodiments, display computing devices 102 (also referred to herein as display devices 102), which may include desktop or laptop computers, in communication via network 107 with server 101, may include one or more portions of persona based UI notification logic module 105, the latter embodied according to computer processor-executable instructions stored within a non-transitory memory. Additional database storage 103 (also referred to herein as database 103) may be provided, communicatively accessible to server computing device 101.

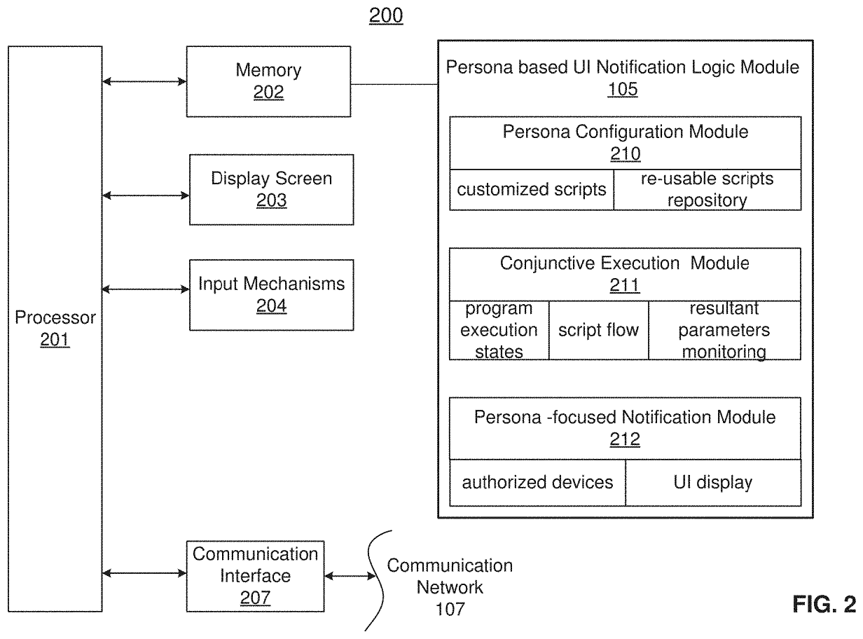

FIG. 2 illustrates, in one example embodiment, architecture 200 of a networked server system for instantiating persona based user interface (UI) notifications in software program execution. Server computing device 101, also referred to herein as server 101, may include processor 201, memory 202, display screen 203, input mechanisms 204 such as a keyboard or software-implemented touchscreen input functionality, and communication interface 207 for communicating via communication network 107. The memory 202 may comprise any type of non-transitory system memory, storing instructions executable in processor 201, including such as a static random access memory (SRAM), dynamic random access memory (DRAM), synchronous DRAM (SDRAM), read-only memory (ROM), or a combination thereof.

Persona based UI notification logic module 105 includes instructions stored in memory 202 of server 101, the instructions configured to be executable in processor 201. Persona based UI notification logic module 105 may comprise portions or sub-modules including persona configuration module 210, conjunctive execution module 211 and persona focused notification module 212.

Processor 201 uses executable instructions of persona configuration module 210 to access a persona configuration, the persona configuration specified at least in part based on one or more script agents arranged in an execution state flow associated with a software program being executed.

In embodiments, a persona may represent a functional user type associated with a business enterprise organization, and the script agents specify the persona configuration in accordance with the functional user type.

The persona may be constituted or at least partly defined based on a set of pre-existing hypothetical user attributes or attribute profile created to anticipate, or respond to an expressed need for, particular information needs of different functional user types. In some embodiments, particular display computing devices, or client devices, may be associated with, and authorized for access and use by a given user type or personas. A persona or functional user type may be identified or determined based on a unique system login or other security credentials assigned and attributed to a given user, regardless of whether a user logs in remotely at desktop and laptop computing devices 102, a mobile computing and communication device, or locally via user input mechanisms 204 at server computing device 101.

In one aspect, the execution state flow comprises a progression of execution states of the software program under execution.

Script agents may be re-used across different persona configurations and software platforms and may be customizable whereby ‘building blocks’ from a scripts agent library or repository are combined to specify a persona configuration representing a unique persona, thereby eliminating or minimizing a need for applying specialized coding expertise to writing script agents or corresponding executable code. A script agent may perform underlying logic of a step, such as writing to a database or making web service calls as linked to code, or monitoring resultant parameters generated during software program execution.

Processor 201 uses executable instructions stored in conjunctive execution module 211 to execute, in the one or more processors 201, object code of the software program in accordance with the execution state flow in conjunction with the one or more script agents to generate a set of program execution resultant parameters, referred to herein as resultant parameters.

Resultant parameters as referred to herein may include interim results derived or calculated during execution of the software program, as the execution progresses or advances in an execution state flow or stages of program execution. Resultant parameters as referred to herein may also include final results derived or calculated once program execution is complete, having advanced through all stages or states of execution state flow.

In one embodiment, during execution of the software program, causing the software application to advance through a series of execution states, one or more script agents specifying a sequence of execution steps based at least partly on the user type information may be executed concurrently with object code of the software program. The one or more script agents that constitute a persona configuration may execute concurrently with object code of the software program to advance or progress through a flow of execution program states to generate program execution resultant parameters.

In some embodiments, the resultant parameters may be derived in accordance with either an interim execution state or a final execution state of the software program during the progression of execution states.

Processor 201 uses executable instructions stored in persona focused notification module 212 to transmit, to a user interface (UI) display of a display device that is authorized in association with the persona configuration, information instantiated based at least in part on the resultant parameters. Such authorization, in some embodiments, may be based upon security log-on credentials assigned with a correlated persona configuration for accessing the display device 102.

Persona based UI notification logic module 105 may include additional instructions executable in processor 201 to store, in a communicatively accessible repository of script agents, the one or more of the script agents, which may be re-used or used as building block creating script agents for additional personas or functional user types of an enterprise organization. For example, the stored script agents may be hosted in memory 202 of server device 101 or at database 103 communicatively accessible to server 101 and computing devices 102.

Persona based UI notification logic module 105 may include additional instructions executable in processor 201, for monitoring generation of the set of resultant parameters and transmitting, during execution of the software program, the set of resultant parameters to a UI display of a client display device that, in a cloud based network arrangement, is remotely located from, and communicatively coupled with, the server device.

In embodiments based on such monitoring, notifications may be generated and presented even during software program execution, depending on whether the particular program state flows for a given script agent(s) have advanced enough such that the resultant parameters associated therewith are instantiated. Thus, in such embodiments, there is no need to wait for full program execution to be complete, as long as the resultant parameters associated with the given persona configuration have been generated. This enables instantiation of real-time notifications for personas in accordance with the persona configurations as defined or specified via computing or communication devices authorized in association with the given persona.

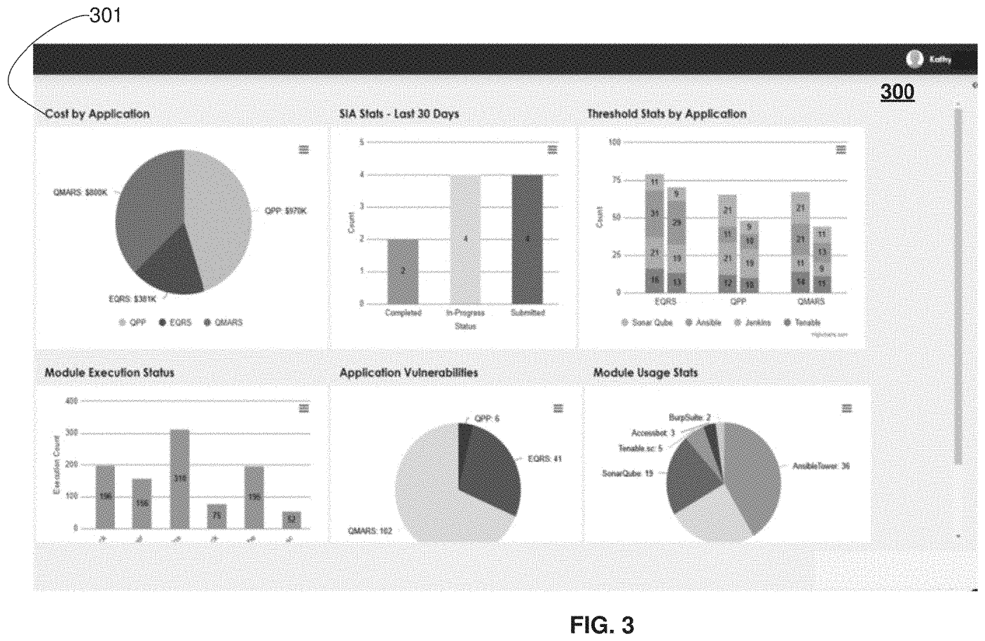

FIG. 3 illustrates a portion 300 of a persona based UI notification as instantiated in an illustrative example. Example created persona corresponding to persona notification UI portion 300 may represent a type of organizational user that may use a software program to acquire certain enterprise information or metrics. The user type or persona represents and encapsulates a unique set of user characteristics or organizational attributes, such as the persona's associated functional position or title that drives a distinctive set of program execution resultant parameters. User types may be created based on enterprise-specific data setups to enable rapid identification of information critical to a given persona for making rapid and effective business decisions, for example.

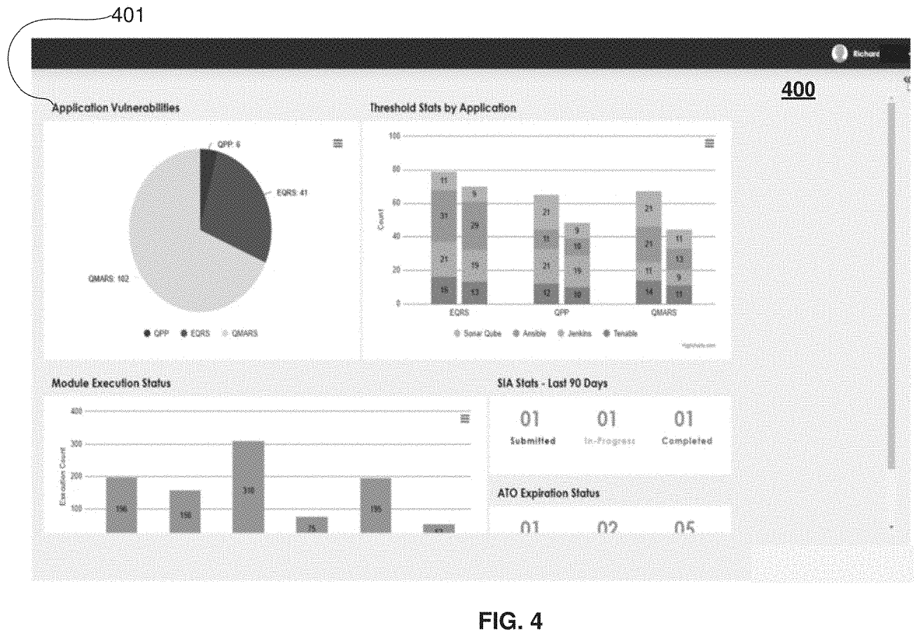

FIG. 4 illustrates a portion 400 of a persona based UI notification as instantiated in a further illustrative example. In the illustrative embodiment 400 depicted, it is contemplated that the information presented to different personas will be at least partly different, or presented in a different order or priority, depending on the interests of the functional user type represented by the respective personas. For instance, persona 300, in accordance with a corresponding persona configuration, might drive cost information metrics 301 prominently displayed in the UI notification display of their associated and authorized display device 102.

Another persona 400 associated with a respectively corresponding persona configuration might drive security performance metrics 401 that is related to system security performance of the enterprise software and security solutions displayed with higher prominence or rendered in greater detail. It is contemplated that in the illustrative example embodiments 300, 400, a first subset of the resultant parameters may be generated in accordance with persona 300, while a second subset of the resultant parameters may be generated in accordance with persona 400, the first and the second subsets being at least partly different.

### Methodology

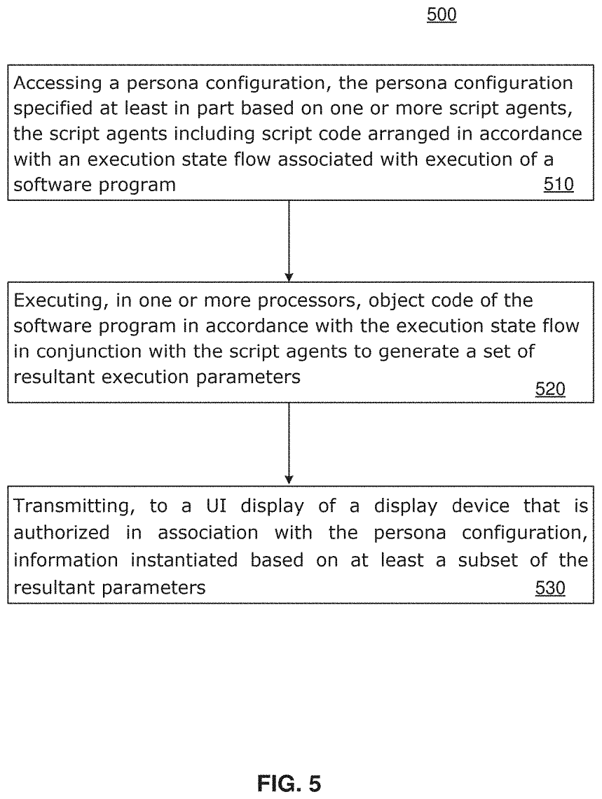

FIG. 5 illustrates method 500 of operation, in one example embodiment, in a networked system of instantiating persona based user interface (UI) notifications in software program execution, performed in one or more processors 201 of server computing device 101. In describing examples of FIG. 5, reference is made to the examples of FIGS. 1-4 for purposes of illustrating suitable components or elements for performing a step or sub-step being described.

Examples of method steps described herein relate to the use of server 101 for implementing the techniques described. According to one embodiment, the techniques are performed by persona based UI notification logic module 105 of server 101 in response to the processor 201 executing one or more sequences of software logic instructions that constitute persona based UI notification logic module 105. In embodiments, persona based UI notification logic module 105 may include the one or more sequences of instructions within sub-modules including persona configuration module 210, conjunctive execution module 211 and persona focused notification module 212. Such instructions may be read into memory 202 from machine-readable medium, such as memory storage devices.

In executing the sequences of instructions contained in persona configuration module 210, conjunctive execution module 211 and persona focused notification module 212 of persona based UI notification logic module 105 in memory 202, processor 201 performs the process steps described herein. In alternative implementations, at least some hard-wired circuitry may be used in place of, or in combination with, the software logic instructions to implement examples described herein. Thus, the examples described herein are not limited to any particular combination of hardware circuitry and software instructions.

Additionally, it is contemplated that in alternative embodiments, the techniques herein, or portions thereof, may be distributed between the computing devices 102 and server computing device 101. For example, computing devices 102 may perform some portion of functionality described herein with regard to various modules of which persona based UI notification logic module 105 is comprised, and transmit data to server 101 that, in turn, performs at least some portion of the techniques described herein.

At step 510, processor 201 of server computing device 101 executes instructions included in persona configuration module 210 to access a persona configuration, the persona configuration specified at least in part based on one or more script agents arranged in an execution state flow associated with execution of a software program.

In embodiments, a persona may represent a functional user type associated with a business enterprise organization, and the script agents specify the persona configuration in accordance with the functional user type.

The persona may be constituted or at least partly defined based on a set of pre-existing hypothetical user attributes or attribute profile created to anticipate, or respond to an expressed need for, particular information needs of different functional user types. In some embodiments, particular display computing devices, or client devices, may be associated with, and authorized for access and use by a given user type or personas. A persona or functional user type may be identified or determined based on a unique system login or other security credentials assigned and attributed to a given user, regardless of whether a user logs in remotely at desktop and laptop computing devices 102, a mobile computing and communication device, or locally via user input mechanisms 204 at server computing device 101.

In one aspect, the execution state flow comprises a progression of execution states of the software program under execution.

At step 520, processor 201 executes instructions included in conjunctive execution module 211 to execute, in the one or more processors, object code of the software program in accordance with the execution state flow in conjunction with the one or more script agents to generate a set of resultant parameters.

In embodiments, during execution of the software program causing the software application to advance through a series of execution states, one or more script agents specifying a sequence of execution steps based at least partly on the user type information may be executed concurrently with object code of the software program. The one or more script agents that constitute a persona configuration may execute concurrently with object code of the software program to advance or progress through a flow of execution program states to generate program execution resultant parameters.

In some embodiments, the resultant parameters are derived in accordance with either an interim execution state or a final execution state of the software program during the progression of execution states.

In accordance with the examples of FIG. 3 and FIG. 4, the resultant parameters may comprise a cost information metrics 301 and system security performance metrics 401 respectively.

In some embodiments, the method may further comprise monitoring the generating of the set of resultant parameters and transmitting, during execution of the software program, the set of resultant parameters to a UI display of a client display device that, in a cloud based network arrangement, is remotely located from, and communicatively coupled with, the server device.

At step 530, processor 201 executes instructions included in persona focused notification module 212 to transmit, to a user interface (UI) display of a display device that is authorized in association with the persona configuration, information instantiated based at least in part on the resultant parameters.

In embodiments, notifications may be generated and presented even during software program execution, depending on whether the particular program state flows for a given script agent(s) have advanced enough such that the resultant parameters associated therewith are instantiated. Thus, in such embodiments, there is no need to wait for full program execution to be complete, as long as the resultant parameters associated with the given persona configuration have been generated. This manifests real-time notifications for personas in accordance with the persona configurations as defined or specified and computing or communication devices authorized in association with the given persona.

In some embodiments, the information as presented at display device may be reconfigured based upon data of the resultant parameters. Some aspects, as depicted in FIGS. 3 and 4, may be presented in various visual formats, such as bar charts or pie charts. For such embodiments, the data of the resultant parameters may be reconfigured based upon further mathematical or statistical treatment, including but not limited to averaging or agglomerating, and ranking and prioritizing of the data and variables of the resultant parameters. In some embodiments, personas as associated with respective authorized display devices 102 may be further authorized to specify formats and formatting of the data and specific variables for the information display.

In an additional embodiment, the display device 102 includes a security configuration that allows access to the display UI only upon authentication using security credentials associated with a persona in accordance with the persona configuration.

Persona based UI notification logic module 105 may include additional instructions executable in processor 201 to store, in a computer-readable memory or other non-transitory storage medium, one or more generated script agents constituted of script code as a script component or model for future use.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments.

As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mention of the particular feature. Thus, the absence of describing combinations should not preclude the inventors from claiming rights to such combinations.

1. A method of instantiating a user interface (UI) notification, the method comprising:
accessing a persona configuration, the persona configuration specified at least in part based on one or more script agents, the script agents including script code arranged in accordance with an execution state flow associated with execution of a software program;
executing, in one or more processors of a server device, object code of the software program in accordance with the execution state flow in conjunction with the one or more script agents to generate a set of resultant parameters; and
instantiating, for transmission in real-time during the executing, one or more notifications to a UI display of a display device that is authorized in association with the persona configuration, the one or more notifications based on at least a subset of the resultant parameters.

2. The method of claim 1 wherein a persona represents a functional user type associated with a business enterprise organization, and the script agents specify the persona configuration in accordance with the functional user type.

3. The method of claim 1 wherein the execution state flow comprises a progression of execution states of the software program under execution.

4. The method of claim 3 wherein the resultant parameters are derived in accordance with one of an interim execution state and a final execution state of the software program during the progression of execution states.

5. The method of claim 4 wherein the resultant parameters comprise at least one of a cost performance metric and a system security performance metric.

6. The method of claim 1 further comprising monitoring the generating of the set of resultant parameters and transmitting, during execution of the software program, the set of resultant parameters to a UI display of a client display device that, in a cloud based network arrangement, is remotely located from, and communicatively coupled with, the server device.

7. The method of claim 1 wherein the display device includes a security configuration that allows access to the display UI only upon authentication using security credentials associated with a persona in accordance with the persona configuration.

8. The method of claim 1 further comprising storing, in a communicatively accessible repository of script agents, at least one of the one or more of the script agents.

9. The method of claim 1 wherein the persona configuration is a first persona configuration, the display device is a first display device, the subset of resultant parameters is a first subset, and further comprising at least a second persona configuration, at least a second display device authorized in association with the at least a second persona configuration, and at least a second subset of resultant parameters.

10. The method of claim 9 further comprising:
transmitting, to a UI display of the at least a second display device, information instantiated based at least in part on the second subset of the resultant parameters, the second subset being different from the first subset.

11. A server computing device comprising:
one or more processors;
a non-transitory memory storing a set of instructions, the instructions executable in the processor to:
access a persona configuration, the persona configuration specified at least in part based on one or more script agents arranged in an execution state flow associated with execution of a software program;
execute, in the one or more processors, object code of the software program in accordance with the execution state flow in conjunction with the one or more script agents to generate a set of resultant parameters; and
instantiate, for transmission in real-time during the executing, one or more notifications to a user interface (UI) display of a display device that is authorized in association with the persona configuration, the one or more notifications being instantiated based at least in part on the resultant parameters.

12. The server device of claim 11 wherein a persona represents a functional user type associated with a business enterprise organization, and the script agents specify the persona configuration in accordance with the functional user type.

13. The server device of claim 11 wherein the execution state flow comprises a progression of execution states of the software program under execution.

14. The server device of claim 13 wherein the resultant parameters are derived in accordance with one of an interim execution state and a final execution state of the software program during the progression of execution states.

15. The server device of claim 14 wherein the resultant parameters comprise at least one of a cost performance metric and a system security performance metric.

16. The server device of claim 11 further comprising instructions executable in the processor to monitor the generating of the set of resultant parameters and transmitting, during execution of the software program, the set of resultant parameters to a UI display of a client display device that, in a cloud based network arrangement, is remotely located from, and communicatively coupled with, the server device.

17. The server device of claim 11 wherein the display device includes a security configuration that allows access to the display UI only upon authentication using security credentials associated with a persona in accordance with the persona configuration.

18. The server device of claim 11 further comprising storing, in a communicatively accessible repository of script agents, at least one of the one or more of the script agents.

19. The server device of claim 11 wherein the persona configuration is a first persona configuration, the display device is a first display device, the subset of resultant parameters is a first subset, and further comprising at least a second persona configuration, at least a second display device authorized in association with the at least a second persona configuration, and at least a second subset of resultant parameters, the first subset being different from the second subset.

20. A non-transitory computer readable medium storing instructions executable in one or more processors of a computing device to:
access a persona configuration, the persona configuration specified at least in part based on one or more script agents arranged in an execution state flow associated with execution of a software program;
execute, in one or more processors, object code of the software program in accordance with the execution state flow in conjunction with the one or more script agents to generate a set of resultant parameters; and
instantiate, for transmission in real-time during the executing, one or more notifications to a user interface (UI) display of a display device that is authorized in association with the persona configuration, the one or more notifications being instantiated based at least in part on the resultant parameters.
